(19) United States
(12) Patent Application Publication
(10) Pub. No.: US 2002/0198723 A1
(43) Pub. Date: Dec. 26, 2002

(54) Method and system to broker artistic projects

(76) Inventor: Craig Peterson Mowry, Southampton, NY (US)

Correspondence Address: Craig Mowry, 95 South Main Street, Southampton, NY, 11968, US

(21) Appl. No.: 09/883,936

(22) Filed: Jun. 20, 2001

(51) Int. Cl. G06F 17/60

(52) U.S. Cl. 705/1

(57) ABSTRACT

Members of an Internet community agree to receive notifications of communications awaiting them in private “mailboxes” assigned to these members, once they have been verified and accepted by the service hub as valid members of the community. PROJECT members proffer opportunities for ARTISTS within their project(s,) including the parameters for these artist(s) to participate in the project(s.) These artists being addressed by their actual name, for those artists who are commonly name recognizable, or the artists are determined by a subjective review, by a human service staff component of the community, of artist criteria submitted by the PROJECT member.

Based on a multi-level “pyramid” negotiating construct, or framework, a PROJECT member must reply to communications within terms, including timeframe of responses, in order to avoid penalties; ARTIST members must reply to communications to avoid loss of membership and/or fewer creative opportunities being relayed to them by the service staff of the service.

The potential for entirely Internet-based communications through the negotiating process and consummation is possible through the service, though most likely the service will facilitate members getting through initial stages of deal-making, toward final verbal or face-to-face consummation of a negotiation.

### BACKGROUND OF THE INVENTION

Currently in a number of creative industries there is a “rift” between recognized creative talent, or “name” talent (commonly known and recogizeable artists often considered “celebrities”) and many projects. The projects are often smaller budget endeavors that many automatically assume that “name” talent would not consider, though in fact the priorities of name talent often are mistakenly assumed. This particular rift creates and opportunity for a new method and system from servicing artists beyond just “name” talent and beyond projects seeking such talent.

“Agents” representing top artists are often limited in the time that they can devote to each artist, thus creating an invisible “floor” to the offers (financially) that these top agents often will even review. Naturally, as a commissioned “rep,” an agent must, for business reasons, often maximize the revenue of a project to the agency as a priority, often over project content, whereas the artist in some cases might choose to forego revenue during a period of time in order to focus on a career building, or artistically appealing project. With the agent as exclusive “conduit” to a “name” artist in many cases, these important artistic projects often do not make their way to the artist for personal consideration. Perhaps the only such projects that do make it to the artists are presented by friends or others who have direct contact with the artists. This issue is that “agents” are inherently biased regarding projects for their clients. A new “type” of agency must exist, which handles the niche of work that is desired by artists for their creative careers, which empowers smaller projects with those artist's names and importance, and which do not hold the proper incentive for the (five) larger agencies of the entertainment arts for proper promotion and consummation of deals related to that niche of work.

Without precluding the agent's fee or representation, an electronic “village” including a closed mailing system, and confidential review staff, would allow for a myriad of projects, big and small, to be forwarded to name talent on their request, for their personal review. For a name artist represented by an agency and even a manager, this service would allow for peripheral projects and options to be forwarded to the artist AND/OR the agent, at the artist's request, that otherwise might not have come to their awareness. Further, this service would provide a “one stop shop” for producers, casting agents, filmmakers, ad agencies and the like to painlessly offer a project to an artist that they might otherwise not feel comfortable contacting, directly or through an agent.

The issues that this service, which incorporates Internet communications elements with live personnel, rendering subjective decisions regarding communications between members of the service, include: Artists' inability to broadcast their true thresholds and parameters regarding projects, and their willingness to negotiate and accept certain projects, for fear of degrading their industry-known value or damaging relationships with representatives; Project-makers', or producers' fear or lethargy in venturing through the gauntlet of often difficult, interpersonal communications with artists' representatives toward even having their project mentioned to an artist, most likely with inaccuracy and bias should their creative opportunity not hold enough financial reward potential for the representative.

### OBJECT OF THE INVENTION

A system including an interactive, Internet site coupled with a human-personnel staffed hub, designed for subjective review and transmittal of electronic communications between members of a service, for the purpose of private and expeditious negotiation of projects otherwise unlikely to be negotiated between these members, outside of the system. The methods involved, including a multilevel brokered negotiating construct which governs the negotiation process of this system, facilitate smaller creative projects being considered by larger creative artists; smaller referring to the project budget available and larger referring to the familiarly marketed value of creative artists' services.

### SUMMARY OF THE INVENTION

The invention, with an alias working title CREATIVE CONFIDENTIAL (“CC”) is a vertically integrated, creative bridge dedicated to bringing forth, and taking an interest in, an untapped range of entertainment ventures and entities. This service recognizes the needs and restrictions of recognized artists in entertainment in providing a safe, efficient conduit to quality projects that might not otherwise be presented for consideration.

This innovation involves a comprehensive Internet site component. Although, this service is indeed not an automated “dot corn.” The personalized services of CREATIVE CONFIDENTIAL address the gamut of issues and concerns that might arise for independent project makers and artists in “connecting” both sides of the creative equation.

An “artistically motivated” project matchmaker, CREATIVE CONFIDENTIAL is positioned as a powerful ally to the artist in entertainment, driven by opportunity and quality before budget and project “size.” In doing so, CREATIVE CONFIDENTIAL can empower “smaller,” content-driven projects to find larger audiences and commercial potential, by making selected recognized artists (actors, directors, writers,) accessible to artistic opportunities which they must also source, to grow creatively.

This is not a “list of artists” and “list of projects” scenario: This site and service achieves a new level of discretion and possibilities in bridging land-locked creative entities that will result in additional work occurring beyond what is typically produced for the screen, stage, microphone and page. This approach is new and the need for a simple, proactive option is significant and timely. Important as the referral service will be, the larger values of CREATIVE CONFIDENTIAL are in revenue areas benefited by the unique vantage point the service itself builds; valuable data informing equity interest and production partnering opportunities for CREATIVE CONFIDENTIAL, exclusively.

The confidential, closed nature of the “offer making” process would ensure that the talent does not become perceived as generally available at rates other than their normally promoted value; the talent would not receive communication from any entity making an offer for his services, other than by relaying by CC personnel who deem the communication to be appropriate for the talent- thus precluding inappropriate contact. Talent, or “artists,” would have the option of passive membership, meaning that after they log on and join the community, offers that happen to be made to them that the site deems legitimate are forwarded to the talent's designated email address OR talent can have active membership, wherein they identify parameters of projects and terms they are interested in seeing CC locate on their behalf.

All offers to talent would be made as GROSS, meaning that they include whatever agency commission a talent typically pays for any agency reps. Should there be no agency representative for selected talent, naturally this margin would be for the talent to keep. A stringent series of “levels” are involved in the process between talent and project, leading to a meeting that can occur securely at CC facilities or elsewhere at the talent's discretion, toward consummating an agreement between talent and project. CC would receive a fee from the project maker which would be deducted out of their gross offer before relaying the revised gross fee to talent or talent rep. CC would assume no responsibility of involvement in the financial transaction between talent and project, though a security fee at least equal to the total fee due to CC on a project offered would be taken from project makers at an agreed level of negotiation between them and their requested talent. CC is an introduction and communication facilitation service.

Further, a credit card security would be taken, (perhaps $1,000,) from any CC accepted offer from a project maker to ensure that should the requested talent respond affirmatively and the project maker should break off the offer before the talent may, the security is kept by CC to compensate for the loss of time and effort from the project maker not following through. This vehicle would be in place to discourage bogus offers and those using CC to test the threshold of talent without committing. A second security might be take later, perhaps the full service fee, as communication advances to final stages.

All in all, CC is a private, staff-reviewed meeting place between projects and artists that will serve to enhance more projects with top-name talent and serve to enhance the careers of top artists by bringing quality project to their awareness. Further, CC will become a painless resource of casting directors and most likely larger producers, in contacting top-name talent in scenarios (where time in calling dozens of reps and networking and negotiation and phone-tagging with people to simply check interest level of celebrities, for instance.) Though designed to be a way for smaller projects to find “bigger names,” it is likely that such a confidential community, where opportunities can be reviewed privately and where celebrities can find work that their representative may not, will become a widely used industry resource for both independent and studio projects, television, theatre and eventually many other creative art industries. Eventually, even agents will find CC to be a business building resource, broadening their reach to projects and opportunities for their clients.

### BRIEF DESCRIPTION OF THE DRAWINGS:

FIG. 1 illustrates the component interaction of the system, method or venue, which allow for a structured negotiating process between project-makers, and artists potentially rendering services to those projects.

“SAR” stands for SPECIFIC ARTIST REQUEST, wherein a project is requesting the services of an artist by name.

“APS” stands for ARTIST PARAMETERS SEARCH, wherein a project-maker defines a range of artists by trait, creative parameters or other variables, which may be acceptable for their proffered opportunity.

FIG. 2. illustrates the levels of negotiation provided within the framework of the system, method or venue, identified for reference by an assigned color code.

FIG. 3 illustrates the component of the system, method or venue which involves Internet based communication, utilizing electronic means to convey information between humans, including artist members, project-maker members and the human staff which subjectively filters and relays communication between members by way of private, member mailboxes.

### DETAILED DESCRIPTION OF THE INVENTION:

Herein is described a system including an interactive, Internet site coupled with a human-personnel staffed hub, designed for subjective review and transmittal of electronic communications between members of a service, for the purpose of private and expeditious negotiation of projects otherwise unlikely to be negotiated between these members, outside of the system. The methods involved, including a multilevel brokered negotiating construct which governs the negotiation process of this system, facilitate smaller creative projects being considered by larger creative artists; smaller referring to the project budget available and larger referring to the familiarly marketed value of creative artists' services.

In providing an non-interpersonal, artistically motivated electronic “broker” of artistic projects, artists may be available discreetly for less lucrative, more creative artistic project opportunities, and projects may have their project opportunities potentially relayed directly from such a “broker” and the artist himself. Should the artist consummate an arrangement on such a project, the overall value and eventual audience of the project is almost certainly enhanced. Further, no representatives have been omitted by the system, as all financial aspects of such negotiations through this “broker” are at GROSS, meaning that commissions are inclusive for the ARTIST to relay to their representatives as they like, on receipt of funds from the PROJECT-MAKER. This “broker” in no way handles funds beyond the fee for the service from the project maker, and any security deposits taken to assure participation by project makers within terms of the service.

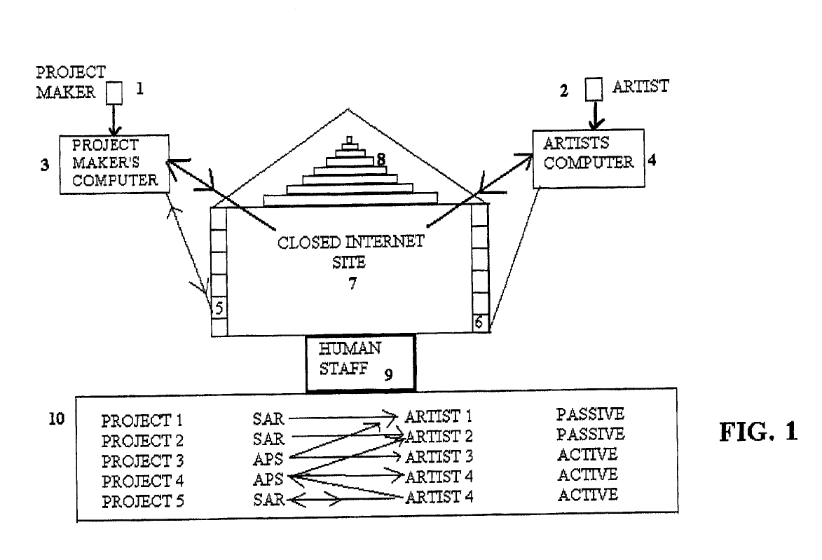

Referring to FIG. 1, PROJECT MAKER 1, utilizes his computer 3, to access the Internet site of the service 7. Artist 2 accesses via his computer 4, to the Internet site 7. The site 7, provides interactive screens to these computers 3 and 4, to allow for mailboxes 5 and 6, to be assigned and for these potential members after their identities have been confirmed by the human staff of the service 9. (The system and method may be interchangeably referred to as the service or venue.)

Artist 2 relays selected personal contact information via computer 4 to site 7, which includes his personal email address. Site 7 will automatically email computer 4 when staff 9, places correspondence in his private email box, 6, to allow artist 2 to use a supplied URL link to go quickly to his sign-in, password page provided by site 7, to allow him to open the private project opportunity directly, for quick review. In this instance, ARTIST 2, has received a specific project opportunity proffer from a project, as seen in 10.

The site 7, provides selectively pre-made screens with data field options to facilitate communication between members, via the staff 9. As in FIG. 4, These may include SIGN IN or ID screens/pages 50 and 60; new member applicant profile forms to complete, for contact and related identification information 51 and 61; ACTIVE MEMBER data providing options/screens 53 and 54 for ARTISTS/TALENT, wherein parameters of willingness to consider projects, such as location, fee, time frame, content, are provided to the site 7 for cataloging in database 10 for review by staff 9 in relaying options to artist 2. A series of feedback screens with response times provided as terms of membership are demonstrated by 52, 55, 56, 57 and on the PROJECT MAKERS' side, 62, 64, 65, 66, and 67. Project maker 1, may define the type of artist sought for a project by site-provided data field options, or his own criteria (long form,) in fields within screen 63.

Site pages familiar to most interactive venues include flash start page, home page, rules page, legal and about and contact pages, such as in 70, 71, 72, 73 and 74.

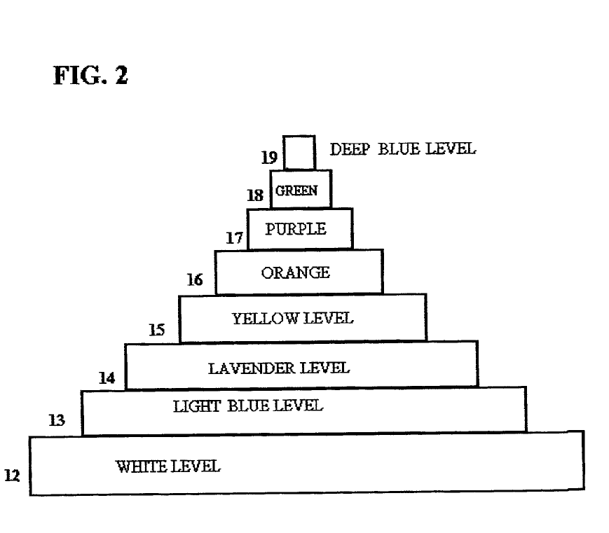

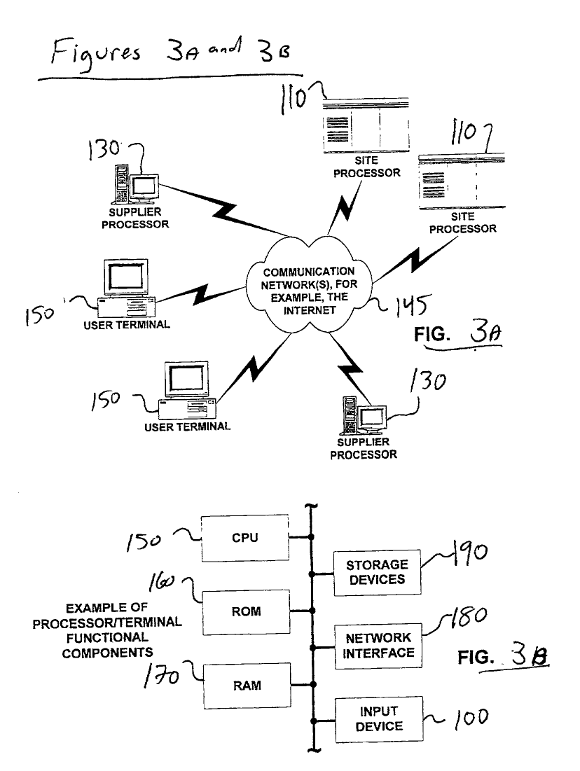

In FIG. 1., the “pyramid”8, represents the basis of all communications between artists and project makers, including the timing and rules governing membership within and use of the service of this invention. 8 is diagramed in detail in FIG. 2. At the WHITE LEVEL, 12, an applicant joins and receives a private member mail box, which is password protected for that member's use. Their identity is subsequently confirmed form information such as social security and artists' guild number. At the LIGHT BLUE LEVEL, 13, the PROJECT MAKER extends and initial offer to an artist, or begins an artist search by defining criteria for the STAFF 9, to suggest artist options for the project maker, 1. A security may be taken from the PROJECT MAKER at this stage, perhaps on a credit card to ensure participation within the rules and time frames of the service, as now an artist is being potentially involved in a negotiation. At this stage the initial offer is made, 62.

At the LAVENDER stage 14, the ARTIST replies within a prescribed time frame to the proffered opportunity, or else it is considered void. If reply comes within the time frame prescribed for ARTISTS at this stage, that ARTIST 2, will define parameters 52, within the offer that are acceptable or which require revision to meet the ARTIST's willingness to continue negotiations. At the YELLOW STAGE, 15, the PROJECT MAKER replies within a prescribed time frame to any ARTIST's feedback which has been relayed to their mail box, 5, to avoid penalty, such as loss of a security deposit, or voiding out of the negotiation. If the PROJECT MAKER replies within the time frame prescribed, he refines his terms to make a revised offer to the talent, 64. The ARTIST replies to this revision 64, within a time frame prescribed again by the service, to accept the scenario proposed or to request further refinement, 55. The PROJECT at this ORANGE stage, on receipt of response 55, may request a meeting with the ARTIST, either supervised by staff 9, or at the ARTIST's choice of location, such as at an agent's office; this request for a meeting to consummate represents the PURPLE STAGE, 17. If PROJECT MAKER flatly denies the response of the ARTIST and ends the negotiation, he may be subject to penalties if staff 9 determines that the ARTIST met the terms provided in response 64.

At the GREEN STAGE, 18, the ARTIST agrees to meet or rejects the negotiation. Should they meeting occur, that is the DEEP BLUE LEVEL, 19, wherein a deal is either struck in a live or phone meeting, or the project offer is shelved if no deal is possible. Shelving a project at this stage may include a provision to preclude the members from working together for a period of time on any project, without an appropriate fee being relayed to the service, for having made the “match.”

So, an entirely electronic series of communications allowed the members to get through the difficult initial stages of refining parameters and issues toward a constructive meeting meant to close a deal. Typically, these early stages are so encumbered with telephone and interpersonal communications with representatives that CASTING DIRECTORS must be hired simply to interface for the PROJECT MAKER to navigate this intimidating gauntlet. More deals on smaller, content-driven projects will be possible by way of this niche “broker” and artistically driven, Internet driven match-maker.

The nature of the present invention is such that one skilled in the art of writing computer executable code (software), will be able to implement the described functions using one or a combination of popular computer programming languages such as “C++”, Visual Basic, Java or HTML and/or web application development environments. As discussed above, one of the functions performed by the system is operation as a web site.

A web site typically communicates with web browsers using the hypertext transfer protocol (HTTP) to send and receive data including hypertext mark-up language (HTML) web page data and executable JAVA Applets. Of course, any known data transfer protocol and web site configuration/definition language can be used to implement the present system as shown in the accompanying figures.

Although the present invention is described by way of example herein in terms of a web based system using web browsers and a site processors, the system is not limited to that particular configuration. It is contemplated that the system can be arranged such that user terminals can communicate with, and display data received from the system using any known communication and display method, for example, using a non-Internet browser WINDOWS viewer coupled with local area network protocol such as Internetwork Packet Exchange (IPX).

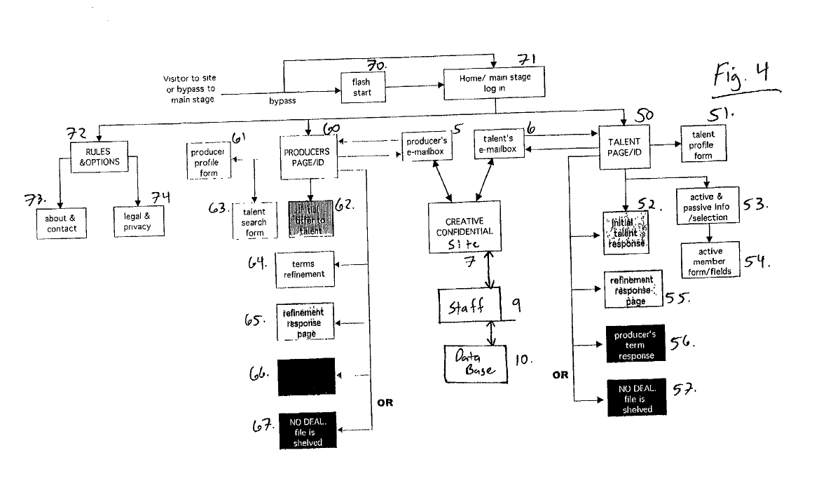

As shown in FIG. 3A, the system in accordance with the present invention includes one or more site processors 110, one or more user terminals 120 and one or more supplier processors 130 coupled together through communication network 145.

Although shown as a single communication network, communication network 145 can be comprised of multiple interconnected networks, for example the Internet. As such, communication network 145 can be any communication network, but is typically the Internet or some other global computer network. Communications between the elements of the present system can be implemented using any known arrangements for accessing the communication network 145, such as dial-up serial line interface protocol/point-to-point protocol (SLIP/PPP), Integrated Services Digital Network (ISDN), dedicated leased-line services, broadband (cable) access, frame relay, Digital Subscriber Line (DSL), asynchronous transfer mode (ATM) or other access techniques.

The user terminals 120 have the ability to send and receive data across communication network 145, and the ability to display the received data on a display device using appropriate communication software such as an Internet web browser. By way of example, terminal 120 may be a personal computer such as an INTEL PENTIUM-based computer or an APPLE MACINTOSH computer, but is not limited to such. Other such terminals which can communicate using a global computer network such as palm top computers, personal digital assistants PDAs) and mass-marketed Internet access devices, i.e., WEB TV, can be used.

Accordingly the user terminals 120 provide access to the site processor 110 for the purpose of accessing the electronic architecture (database and database management system) of the present invention. The system software which controls the above-described functions relies primarily on the one or more site processors 110. Site processors 110 typically communicate with network 145 across a permanent i.e., unswitched, communication link. Permanent connectivity ensures that access to server 110 is always available to terminals 120.

Site processors 110 can be any appropriately sized computing platform, the storage, processing and other functional capacities of which are determined based on expected user activity and data storage requirements. For example, site processors 110 can be server-type personal computers, mini-computers such as UNIX-based servers, and even mainframe computers.

Supply processors 130 are preferably owned and maintained by the entities of supplying goods and services for marketing. Supply processors 130 are preferably used for receiving demographics, marketing and sales data from site processors 110 and for providing corporate, product and service and other relevant information to site processors 110, terminals 120 and LIVE SHOW processors 140. Further, orders for goods and services placed by users via user/player terminal 120 can be accepted directly from user terminals 120 or via site processors 110.

As shown in FIG. 3B, the functional elements of each site processor 110 preferably include a central processing unit (CPU) 150 used to execute software code in order to control the operation of the server, read only memory (ROM) 160, random access memory (RAM) 170, at least one network interface 180 to transmit and receive data to and from other computer devices across communication network 145, storage devices 190 such as a hard disk drive, floppy disk drive, tape drive, CD-ROM, DVD-ROM and the like for storing program code, databases and application data, and one or more input devices 100, such as a keyboard and mouse.

The various components of site processor 110 need not be physically contained within the same chassis or even be located in a single location. For example, the database on storage device 190 may be located at a site which is remote from the remaining elements of site processor 110, and may even be connected to CPU 150 across communication network 145 via network interface 180.

Terminals 120 and supply processors 130 are preferably comprised of the same or subset of the functional components described with respect to the site processors 110. Of course, the functional components of these devices are sized to accommodate capacities appropriate for their usage. For example, terminals 120 may include more sophisticated displays and display driving hardware than the other elements, but may contain a smaller storage device, and less powerful CPU 150 than the other components. Also, supplier processor 130 may contain a more powerful CPU 150 than site processor 110, especially in the case where supplier processor 130 is implemented by a large corporation with a sophisticated Internet presence.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

### Further Disclosure

The preferred configuration of the present invention, though not limited to the following, is described herein relative to an entertainment artist/project scenario where a firm employing the related method and system which is name “CREATIVE CONFIDENTIAL.”

IT IS: A secured live, interactive entertainment resources site dedicated to bringing name talent to viable projects and opportunities in film, television, theater, multimedia, etc., while allowing producers/developers of these projects easy, anonymous e-mail access to verified name talent.

STRUCTURE and FLOW: Creative Confidential (heretofore mentioned as CC) breaks into two key segments for site interactivity; a Producer section and a Talent section. (“Producers” being those who have a project requiring talent, and “Talent” being ARTISTS, actors, writers, directors, DP's, and possibly crew). Key services of the site are to quietly generate Talent interest by viable Producers, establish Talent identity, and verify a Producer's viability. All of this is carried out by way of e-mail boxes assigned to respective Talent and Producers for the aforementioned correspondence.

Internally, all mail boxes would be numeric with Talent mail boxes beginning with a “T” while Producers boxes would begin with a “P”. They will be alias capable by the user. Both Producers and Talent register in respective interactive forms the pertinent information that would allow them to utilize the CC services.

Policy is that no contact numbers are issued out to Producers. Phone numbers and addresses and other information ARE submitted by inquiring Producers (“P”.)

Any contact between parties other than via of CC is at the approval and agreement of both parties through CC e-mail. An exception to this may be the initiation of a conference call THROUGH CREATIVE CONFIDENTIAL's own phone system to maintain security with the interested Producer with talent and/or agent. Conversely, any requested live meetings that are agreed upon between Producer and Talent could take place within the CC law office location, should the Talent choose to do so. Any subsequent access to boxes by Producers or Talent, their mailbox can be reached through password entry without the runaround of multiple page navigation.

Example: A Producer makes an inquiry to Talent regarding the project to which the Producer has intent to develop and how they envision the Talent's involvement. Within that e-mail, a complete form is included to cover areas of pertinence, i.e. Wants & Needs, money, accommodation, travel, perks, dining, etc. After CC's groundwork study is completed and the Producer and project are deemed viable, the Talent receives a notification to their designated personal e-mail address from CC that there is correspondence received at their CC box that carries a project inquiry. The Talent can access the CC site by a link within the notification mail and is subsequently brought to the log-in page where they must enter their password to access their CC mailbox containing the inquiry. Another option may be that after initial log-on and submission of identity information to CC by Talent, all offers in their long-form entirety are emailed directly to the indicated Talent email address, in order to avoid Talent having to log on and go through a procedure each time an offer is make to them via CC. Talent (or their agent) may respond via CC to “P”, at which point the Producer is notified of a response by the Talent. CC would typically qualify all “P” and “P” correspondence to Talent. Any requests for face to face meetings can be arranged via CC, and confirmed at “CC's discretion.” All transactions between T and P and all interaction, electronic, written or personal made between T and P would be at the parties' own risk and at their discretion.

Those with projects requiring talent may submit their requests/bids for T desired, with a standard monetary deposit of some substantiality for two reasons;

1. To verify the viability of Producer offer;

2. To cover expenses undertaken in the event of early deals that are not followed through on the Producers part. It would be at CC's discretion when such a lack of follow through would be deemed to have occurred. This “deposit” would be held only as long as the P designated the contact with requested T should occur; should there be no response by T within that time frame, the deposit would be returned to P under CC conditions agreed to by P.

Should an offer made be returned with a favorable response from talent, an information request to the Producer would be made in order to carry out a simple credit and more comprehensive identity check to verify that the funds offered for talent exists or that there is access to the required funds to carry out a deal. This information could be incorporated within a “membership agreement”. At this point, it might further be determined that the CC service fee, or another CC determined amount, for the level of transaction occurring would be taken from P and held, with this amount being the “penalty fee” in case of break-down in the dialogue with T by P after a designated level of communication, deemed by CC to be at a more advanced stage, having required significant time from CC and the requested T.

As said, for the sake of maintaining timeframes for the Producer, they need to indicate the period of time CC will retain the Producers initial deposit before P inquiries will remain outstanding at which point the Talent is informed of the time period to respond. The Producers are able to extend searches after a message is forwarded by CC to let them know their period is about to expire. There will be a “extend” button, for instance. Once this time period has expired, the security deposit is automatically returned. Talent that responds to inquiries post the period the Producer designates would require reinstating and redeposit of the project. Conversely, Producers who do not respond to inquiry responses from Talent within a designated period of time (say, 72 hours) may be subject to loss of deposit.

SECURITY/Front End: In the event of duplication of talent boxes, (meaning more than one internet inquiry from different sources claims to be a single artist or T,) a new level of security questions will be applied requesting that the talent requesting access to the mailbox goes through their agent or representative or by written identity confirmation by their guild should no representative exist, or another CC designated form of advanced identity and email confirmation

Those without an agent might be required to navigate additional questions of a nature that would allow a determination that the person attempting a mailbox access is, in fact, the duly authorized person. Or, may have to submit to identity verification by an external firm specializing in such tasks. This process should act as a deterrent to those persons attempting access to unauthorized boxes; those identified as fraudulently accessing information meant for T that they may be pretending to be, would be prosecuted or reported to appropriate agencies, and their email addresses or other information potentially listed within CC's fraud page, within legal allowances.

Also, this can be carried out through an e-mail correspondence to BOTH inquirers requesting a call in (or a physical appearance from the talent to verify their identities and authorization.). We need to maintain steadfast security in that identities that cannot be verified may NOT access a mailbox.

To qualify talent, T, for membership and a forwarding email box at CC, their associate guild would confirm potentially up to 3 key points of data from CC:

1. SAG I.D. number

2. Social Security number

3. Agent or Representative's name

Screening of Producers would likely be a series of ten questions to determine the following:

a) What is the financial backing

b) Timeframe

c) What's the producer's history

d) How will it be marketed/distributed

e) Legitimate crew

f) Other related information of interest to T in considering an opportunity presented.

UPKEEP/MAINTANANCE: The site could likely be monitored by individual(s) who would create a call-list for the following day to SAG or other. This pre-screening process would allow the filtering of viable projects and the individuals behind them. It is likely that a confidential, human reviewer would make decisions on the fate of all correspondence submitted to CC by any parties.

PAYMENT AND PENALTIES: All rates for CC services are gross. For discussion's sake, CC might take a 5% commission for making introductions through the form of a letter of credit. No deals can be consummated through CC without personal/corporate guarantee or credit data attained up front; typically, CC will not be involved in any financial transactions or liabilities, other than the service fee due to CC by P on the proposed work to any T. Any finishing transactions without CC involvement after connections have been established will be regarded as a violation and would be subject to penalties of a CC designated multiple of the original fee to CC. A legal notice to this effect would need to be emphasized that any unauthorized offers consummated between the Talent and Producers that does not properly compensate CC within agreed time frames could be incorporated within the “membership agreement”. (This warning is not altogether different from those deals done on an auction site such as e-bay.)

Agreement violations could result in a lien on the project in question, at CC's discretion i.e. A minimum of $5000 service fee for instance, on viable projects/offers is established. A gross offer of $300,000 is made CC for the T, including any and all service fees from CC, for instance. The Talent is relayed a fee of $25,000, which is the P's budget minus CC service fee, which is to be paid separately to CC by P. T can choose to include his/her Agent, in which their commissioning or fee arrangement with their own agent or rep would be calculated and deducted from the GROSS $25,000 fee from P. In such a situation, it is likely that P would be paying the designated agent or rep of T at this point, paying that representative of T, on T's direction.

As said, as the negotiation of a deal progresses, a security fee is paid up front and placed in escrow. In the event the Talent breaks off talks, the security is returned. If the deal is consummated, the security is applied to the fee to CC.

It's been discussed that the entire fee for CC services is paid by the Producer up-front and placed in Escrow. If a deal is not made due to the Talent declining, it is then returned to the Producer. Such options are at CC's discretion.

RULES, AGREEMENTS, RESTRICTIONS, AND INFO: Within the Talent section, it would be emphasized that total confidentiality is in place, that nothing is binding until T has their own agreement with P, and no release of information from CC will take place other than under T authorization . . . CC can be easily contacted by e-mail or voice by T. All other parties have access to CC by voice at CC's discretion.

Cooperative arrangements with the agents of T is not a problem and encouraged, on permission of T. There is ground- work necessary for CC to qualify and secure funds from all P, as later level's of interaction/negotiation to take place with T is potentially damaging to CC reputation should numerous P's break off talks with numbers T's. Other potential issues that could result from insufficient ground work could be potential copyright infringement of script treatments in part or entirety. CC would be absolved of any copyright problems upon agreement of terms by the Producer who willfully submits scripts or any art for review to Talent established through dialogue made possible by CC or other correspondence between the parties.

Conversely, a copyright notice is revealed to Talent upon the act of “clicking” a script document to open. Talent must traverse through the legal agreement and click “accept” or literally enter the text “I agree” in a field to access the script.

We (CC) do not recommend the release of proprietary art and Producers do so at their own risk and agree to these terms. Multiple notifications occur prior to the e-transfer of intellectual properties to Talent, if the release is done via CC. As Talent and Producers enter fields during their registration process, sundry dialogue boxes give relative information and legal (when necessary) may appear for their edification and CC's indemnification.

Upon a project agreement between Talent and Producer, a final check would take place where the Producer would supply an update after 14 days, for example, of formalized personal contacts/introductions and offers. Last update would be at 30 days confirming whether a finalized contract is in effect or not. In the event that 30 days has past and a deal was unable to be struck, we would submit to the Producer a reminder of the terms stating that the Producer MAY NOT enter into any agreements or transactions on projects with that Talent outside any other means than those undertaken by way of their offer with CC, with the degree of penalty if such transactions occur. Whether fees occur on projects subsequent to the first that occurred from the CC “introduction,” is at CC's discretion.

With an agreement with CC concerning Talent contacted by way of CC services, any arrangements made between that Producer and Talent inside of a year, for example, would include an agreed fee due to CC. The terms would be clear that it is P's responsibility to alert the site inside of 60 days of their intention to work with the Talent. This could apply to a 1 year period of the P's initial registration and Talent offer. It just would not pay for P to circumvent the CC agreement as it would subject the resulting project to lien and P to extensive penalty, further most entertainment projects become visible with related dates of pre-production and production available. As CC is an introduction/broker service, CC would emphasize that CC is not project specific. CC is contact/connection service, specific for a year and one project only, or another CC selected time frame and/or agreed CC service fee terms.

### SITE NOTES and Suggestions

Major campaign direction with this site is that Talent will never see a photo job, listing or bulletin board. It is totally discreet and private. The choice of T to provide CC with a request for “active” promotion of their availability within selected terms designated by T, is available. In such a situation CC would maintain said T on a list with terms considered when relevant P opportunities are made, whether those opportunities from P were made in a more general way, or if P agreed that if CC identifies talent deemed to be similar to other talent requested, P is willing to be contacted by CC to that effect with selected information released with T's permission in such a scenario.

Invalid fields are revealed at the completion of registration forms.

Talent e-mail contact address is a must but phone number field is listed as optional. The Talent can request that either they directly or their agent/rep are informed by phone of any offers in the event that they do not have or check e-mail.

Clear indication that CC cannot be held responsible for lack of response by the Talent for legit offers. The engage in the CC introduction and communication forum procedures at their option, with no guarantees of time frame, results or P legitimacy by CC. Any qualifying by P and T is done by CC, at CC's discretion as a service to CC members, to facilitate real deals occurring.

Notice that any circumvented offers or deals struck outside of CC will be charged a penalty up to 50% of the contract deal, for instance.

CC is contact specific and is only interested in deals struck within a year and one project only. If deals are not struck, we release reminders in selected intervals that would substantiate that no deals are in play to avoid a Producer from stating “No Memory” of agreement terms.

Three T choices to a P offer might be a maximum allowed, for instance; limiting the quantity of offers will maintain overall integrity of CC offered in the minds and perception of all T. Also, the first P requested T to meet the terms and an offer defines a deal committed and P obliged to follow through as proposed; thought CC takes no responsibility legally in such a circumstance, to the agreement of both T and P. CC will however release to T. at CC's discretion, the CC agreement that P made relative to a confirm deal should T choose to separately pursue P for offers not honored. Again, T and P will be clearly informed though, that their only actual confirmation of an agreement between parties, will be their own paperwork, signed in a meeting or agreed venue between T and P, releasing CC from any involvement in confirming agreements; clearly once an agreement is drafted between parties, signing of such an agreement occurs outside and separate from the protection or environment of CC, as CC's task of introducing and providing a communication venue between parties will have been fulfilled, completed and closed with regards to the specific T and P relative to that particular introduction.

Emphasis in a site descriptor would occur: We are not an agency . . . We do not represent Talent for work. We simply act as an introduction service and data exchanging means between parties. We don't represent, indemnify, or speak for projects, Producers, or offers.

Equal safety emphasis must be made to the effect that Talent should not release contact information until the Talent is prepared to assume the exposure of the project. Upon their contractual acceptance of a project, they no longer are under the confidential protections that come from Creative Confidential. T will be requested not to discuss terms of offers made by P via CC other than with agents or reps. Should T do so, in CC's opinion, CC reserves the right to cancel membership, or not accept membership requests from any T, or any P for that matter.

Sanctions: See Rules, Agreements, and Restrictions under Payment and Penalties It will be important to emphasize that Producer's will pay clear, listed substantial penalties should they renege on their agreement with CC.

The site could be color-coded to illustrate level transitions through negotiation. For instance, an initial registration/contact and offering may be at what would be the initial stage, or yellow level. Talent's initial response/contact return would advance the process to blue level. Negotiation toward an agreement under the securities of the CC site is the purple level. As information is volleyed to the point where both Producer and Talent are at comfortable level with the negotiations and mutually agree to have a face-to-face, it advances to the orange level. As negotiations yield a favorable agreement and a contract is to be struck, the deal is moved to the green level. If deals are not struck but need to be maintained for CC security/maintenance reasons, files could be moved to a red level or zone.

Related to the information above, an addendum section can be accessed at the blue or orange levels that would allow both parties to make a special request for further communication via CC, at which point additional details are gathered as needed within CC rules and at CC's discretion

The five levels spell out the communication flow, the fee structure and CC procedure. All breakdown levels will spell out these flows and structures for P's and T's understanding. Deviations from the standard template of the flow of these structures can be requested by way of the CC coordinator's e-mail box for a potentially additional fee, on CC's approval.

Note: Herein where the word PRODUCER or PRODUCERS may have occurred, this relates to P as described, which includes all such creative “project makers.”

Where Talent or Talent's occurs, this relates to T, or all creative talent, not limited to just actors, performers, directors, photographers and other people who are involved in the creation of art and entertainment products. ARTIST and TALENT refer to the same member type.

What is claimed is:

1. An electronic negotiating venue wherein participants of said venue supply and receive communications which are subjectively filtered and relayed by human staff of said venue and wherein said communications are made according to terms and communication data parameters provided by and governed by said venue.

2. An electronic negotiating method wherein members of a community supply and receive communications which are subjectively filtered and relayed by human staff within said community and wherein said communications are made according to terms and parameters provided by and governed by said staff.

3. An electronic negotiating system wherein members of an Internet based community supply and receive communications which are subjectively filtered and relayed by human staff within said system and wherein said communications are made according to terms and parameters provided by said staff, including data format Internet screens which provide input fields for specific member data.

4. A system as in claim 3, including system supplied data formats supplied to members as Internet transmitted screens wherein said specific member data includes member parameters for accepting or proffering a project opportunity.

5. A system as in claim 3, including a standardized framework governing the nature of data exchanged between said members and timeframes in which data exchanges must occur.

6. A system as in claim 3, wherein selected penalties are incurred by selected members of said system for not adhering to said terms and parameters.

7. A negotiating venue as in claim 1, wherein said members include those proffering artistic opportunities within projects and those potentially providing artistic services within said projects.

8. A venue as in claim 7, wherein subsequent stages of negotiation between selected members requiring verbal or interpersonal dialogue are possible within the framework of said venue, including supervision of said verbal or interpersonal dialogue by said staff.

9. A venue as in claim 8, wherein discontinued negotiations between selected members may include selected restrictions of selected future interaction between said selected members.

10. A venue as in claim 7, wherein members must identify themselves with password data in order to access mailboxes within said venue reserved specifically for use by members holding password data to said mailboxes.

11. A system as in claim 6, wherein members may proffer opportunities for other members by identifying members by their actual names.

12. A system as in claim 11, wherein members may proffer opportunities for other members by defining a selected traits which may be deemed by said staff to define selected members appropriate to consider said opportunities.

13. A system as in claim 6, wherein a multilevel procedure facilitates the types of data and time frames of response to communications members must provide to not discontinue negotiations by default.

14. A system as in claim 13, wherein members not following said procedure may incur financial penalties.

15. A system as in claim 14, wherein members following said procedures for a selected period of time may receive selected rewards.

16. A venue as in claim 7, wherein said artistic opportunities proffered include financial benefit, and wherein said this benefit is a gross fee, including potentially familiar financial margins for those providing artistic services to compensate selected representatives.

17. A system as in claim 6, wherein only members may utilize the system to access their communications from other members of said community, with potential penalties applying when primary retrieval of said communications is made by non-members on behalf of a member.

18. A venue as in claim 7, wherein those proffering artistic opportunities may request specific relaying of their opportunities to artists by name or by selected description of a range of artists according to traits.

19. A venue as in claim 7, wherein artists potentially providing said artistic services may passively consider opportunities made specifically to them, or may provide parameter data to the venue for active sourcing of project opportunities for said artists by said staff.
